(19) United States
(12) Patent Application Publication
(10) Pub. No.: US 2014/0244115 A1
(43) Pub. Date: Aug. 28, 2014

(54) DRIVING SUPPORT APPARATUS

(71) Applicant: DENSO CORPORATION, Kariya-city (JP)

(72) Inventors: Norio SANMA, Okazaki-city (JP); Sei IGUCHI, Okazaki-city (JP)

(73) Assignee: DENSO CORPORATION, Kariya-city (JP)

(21) Appl. No.: 14/178,499

(22) Filed: Feb. 12, 2014

(30) Foreign Application Priority Data
Feb. 25, 2013 (JP) 2013-34281

(51) Int. Cl. B62D 15/02

(52) U.S. Cl. CPC B62D 15/02
USPC 701/42

(57) ABSTRACT

A driving support apparatus includes an output unit installed in a steering wheel that outputs steer information about a rotation operation of the steering wheel to the driver through the output unit. By providing the driver with steer information from the output unit in the steering wheel, the driver may recognize the contents of the output of the steer information. Further, since the steer information has a high priority for the driver due to its direct relevance to movement and a travel direction of the vehicle, providing such high priority steer information in an easily-recognizable manner improves driver awareness or readiness to recognize lower-priority information. Thus, information overload by the driver caused by information from various driving support techniques is prevented.

### CROSS REFERENCE TO RELATED APPLICATION

The present application is based on and claims the benefit of priority of Japanese Patent Application No. 2013-034281, filed on Feb. 25, 2013, the disclosure of which is incorporated herein by reference.

### TECHNICAL FIELD

The present disclosure generally relates to a technique for supporting a driving operation of a driver when driving a vehicle.

### BACKGROUND INFORMATION

Various driving support techniques for supporting a driving operation of a vehicle driver have been developed due to the progress of electronics, information processing techniques, control techniques, and the like.

For example, a patent document 1 (i.e., Japanese Patent No. JP-A-H06-117285) provides a technique that, after setting a vehicle speed during a traveling on an expressway or the like, the vehicle maintains the set vehicle speed by performing a required control. As a result, a driver is not required to correct or adjust an acceleration control amount when encountering a slope or a grade.

Further, a patent document 2 (i.e., Japanese Patent No. JP-A-2003-114276) provides a technique in which a driver is notified of obstacles such as a pedestrian, based on a monitoring of a vehicle's surroundings through the use of sonar, radar, and image recognition, etc. A patent document 3 (i.e., Japanese Patent No. JP-A-2004-352120) provides a technique for automatically steering a vehicle during a parallel parking or a backward parking operation.

However, a driver may experience stress and/or fatigue by an increased load of information when provided with too many of such driving support techniques.

In the cruise control technique of the patent document 1, a problematic situations may be caused when the accelerator operation is performed without involving the driver of the vehicle. As a result, a display of an automatic speed-hold control and an acceleration control amount, if appropriate, is required to be constantly displayed to the driver, which should always be clearly recognizable to the driver so that anxiety is not induced/caused by such automatic speed-hold control without driver involvement. In the surrounding monitoring technique of the patent document 2, the result of the monitoring is required to be displayed for the driver. In the technique of the patent document 3, the automatic drive function including a steering amount and direction, if appropriate, should always be displayed so that anxiety is not induced/caused by such an automatic steering wheel operation that is performed without driver involvement.

That is, the amount of information provided for a driver to process increases when more driving support techniques are used in the vehicle. As such, increasing the driver's load of information may cause stress, anxiety, pressure and the like.

### SUMMARY

It is an object of the present disclosure to provide a technique that is implemented in a driving support apparatus, which reduces the load of information received by a driver from various in-vehicle driving support devices.

In an aspect of the present disclosure, the driving support apparatus is installed in a vehicle and supports a driver of the vehicle. The driving support apparatus includes a steering wheel that controls a directional movement of the vehicle, a steer information obtain unit that obtains steer information about a rotation operation of the steering wheel, and a steer information output unit installed in the steering wheel and outputting the steer information to the driver. The driving support apparatus uses a steer information output unit that is installed in a steering wheel for an output of steer information to the driver, i.e., the steer information regarding a rotation operation of the steering wheel.

Since the rotation operation of the steering wheel is directly related to a movement and travel direction of the vehicle, the steer information is information that has high importance for the driver. Further, since the steer information is information regarding the rotation operation of the steering wheel, if such steer information is output from the steer information output unit that is installed in the steering wheel, the driver can readily and intuitively understand the contents of the steer information. Further, if the highly important steer information can be readily understood by the driver, a degree of awareness or readiness of the driver for receiving other information with lower importance in comparison to the steer information is increased.

As a result, even when various kinds of driving support techniques are implemented in the vehicle, which increases the amount of information that is provided for the driver, the driver can receive the information in readiness and/or with ease, thereby preventing the driver from suffering from an overload of information or the like.

Also, in the driving support apparatus of the present disclosure mentioned above, the apparatus may obtain the steer information by detecting that a driver performed rotation operation of the steering wheel (i.e., a rotation operation of the steering wheel that is performed by the driver. In such manner, the steer information is easily obtained.

Further, in the driving support apparatus of the present disclosure mentioned above, the apparatus may obtain a steering direction (i.e., rotation direction) of the steering wheel as the steer information.

The steering direction of the steering wheel is information which shows in which direction the vehicle is traveling or turning, and is thus basic information that should be grasped or understood by the driver. Therefore, by obtaining such basic information and by outputting it to the driver as the steer information, an output of such basic information is readily grasped or understood by the driver, thereby increasing the degree of awareness or readiness of the driver for receiving the other information.

Even further, in the driving support apparatus of the present disclosure mentioned above, the apparatus may obtain a steering speed (i.e., rotation speed) of the steering wheel as the steer information.

The rotation speed of the steering wheel is information which shows a speed of a lane change of the vehicle, and is thus the basic information that should also be grasped or understood by the driver. Therefore, by obtaining and outputting such basic information to the driver as the steer information, an output of such basic information is readily grasped or understood by the driver, thereby increasing the degree of awareness or readiness of the driver for receiving the other information.

Additionally, in the driving support apparatus of the present disclosure mentioned above, the apparatus may visually output the steer information to a driver's visual sense.

By outputting the steer information to the driver's vision, various and many contents are transmitted in a short time, thereby increasing the degree of awareness or readiness of the driver for receiving the other information. As a result, even when an increased amount of information is provided for the driver, an increase of the driver's load is prevented.

Moreover, in the driving support apparatus of the present disclosure mentioned above, the apparatus may tactily output the steer information to a driver's tactile sense.

By outputting the steer information to the driver's tactile sense (e.g., to the driver's hand and/or finger), which are not fully utilized in comparison to the visual sense, an output of the steer information is received by the driver in readiness. As a result, the driver's vision may be used to receive more information, and an increase of the driver's load of receiving information is prevented, even when an increased amount of information is provided for the driver.

Further, in the driving support apparatus of the present disclosure mentioned above, the apparatus may include a drive unit that performs a rotational driving of the steering wheel, and a drive controller that controls the drive unit to rotationally drive the steering wheel. The apparatus may obtain the steering wheel based on a control amount of a control of the driver unit that is controlled by the drive controller.

In such manner, the steer information is obtained by the apparatus and is then output to the driver prior to the rotational drive of the steering wheel by the drive unit.

Even further, in the driving support apparatus of the present disclosure, in case that the drive unit is a unit which can rotate the steering wheel in place of the driver, the steer information may be outputted in the following manner. That is, after determining that a current operation state is (i) a manual driving state in which the rotation operation of the steering wheel is performed by the driver or (ii) an automatic driving state in which the rotation operation of the steering wheel is performed by the drive unit, the steer information may be visually output to the driver's visual sense in the manual driving state or the steer information may be tactily output to the driver's tactile sense in the automatic driving state.

In such manner, in the automatic driving state, even when the driver's hand is removed from the steering wheel, the steer information can be visually recognized by the driver. Further, since the driver is gripping the steering wheel in the manual driving state, the steer information is recognized by the driver by tactile output of the information from the steering wheel.

Additionally, in the driving support apparatus of the present disclosure mentioned above, in case that the current operation state of the apparatus is the automatic driving state, the steer information output unit outputs the steer information to the driver prior to the drive unit rotationally driving the steering wheel.

In such manner, the driver may be notified about the contents of the drive operation by the automatic drive state prior to actual operation (i.e., before the operation is carried out). Such notification may allow the driver to stop and/or prevent an operation which is not in accords with the driver's intention and/or an operation that is unsuitable for the surrounding traffic situation.

### BRIEF DESCRIPTION OF THE DRAWINGS

Objects, features, and advantages of the present disclosure will become more apparent from the following detailed description made with reference to the accompanying drawings, in which:

FIG. 1 is an illustrative diagram of a vehicle that has a driving support apparatus;

FIG. 2 is a block diagram of a vehicle control unit of the driving support apparatus and various devices installed in the vehicle connected thereto;

FIG. 3 is an illustrative diagram of a steering wheel in which a drive information output part is installed;

FIG. 4 is a time chart of an output of the steer information in a visual manner from a first output part;

FIGS. 5A/B/C are illustrations of an output of acceleration/deceleration information in a visual manner from a second output part;

FIGS. 6A/B/C are illustrations of an output of acceleration/deceleration information in a visual manner from the second output part when a steering wheel is rotated;

FIGS. 7A/B are time charts of an output of the steer information in a tactile manner from third and fourth output parts;

FIG. 8 is a block diagram of an internal configuration of the drive information output part;

FIG. 9 is a flowchart of the drive information output process which is performed by the driving support apparatus; and

FIGS. 10A/B are illustrations of the steering wheel in which the drive information output part in a modification example is installed.

### DETAILED DESCRIPTION

In the following, an embodiment is described for clearly conveying what the present disclosure is about.

A. Device Configuration:

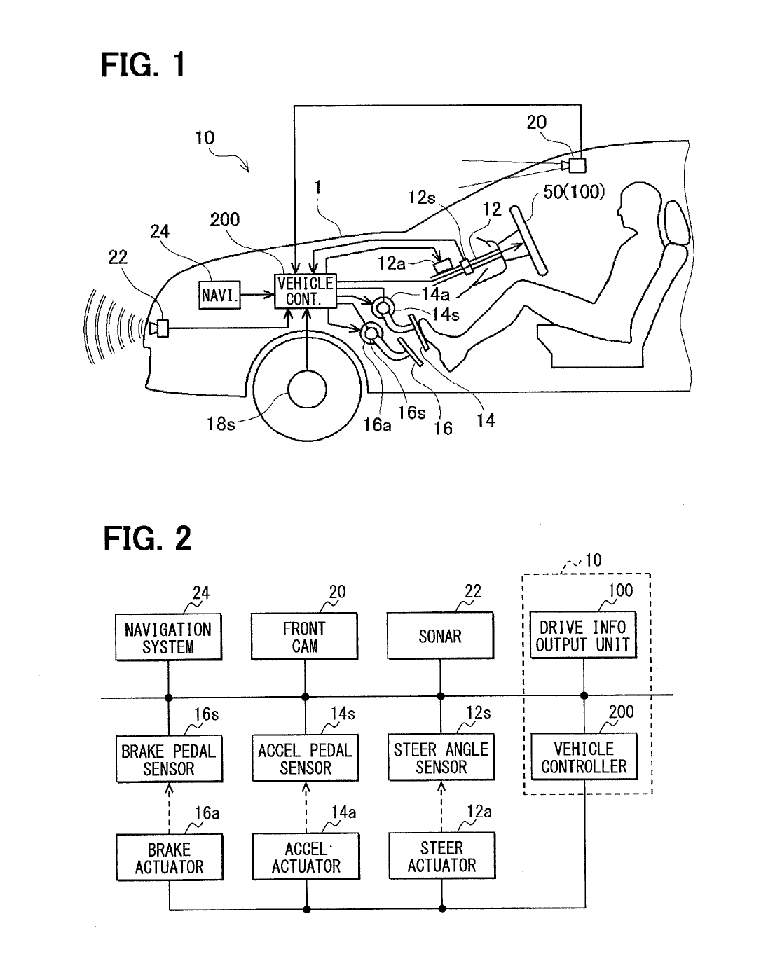

FIG. 1 shows an illustrative configuration diagram of a vehicle 1 that has a driving support apparatus 10 of the present embodiment. The driving support apparatus 10 of the present embodiment is installed in a steering wheel 50, and is provided with a drive information output part 100 which outputs to a driver of the vehicle 1 the information (i.e., drive information) about an operation or a driving of the vehicle 1, a vehicle controller 200 which controls a motion of the whole vehicle 1, together with other components. The vehicle controller 200 is a so-called microcomputer, for example. The vehicle controller 200 is in connection to a steer angle sensor 12s which detects an angle of rotation of the steering wheel 50 (i.e., a steer angle) and outputs, by obtaining the information about the rotation operation of the steering wheel 50 (i.e., the steer information) from an output of the steer angle sensor 12s, the obtained information to the drive information output part 100. The steer angle sensor 12s is attached to a steering shaft 12 which transmits a rotation of the steering wheel 50 to the vehicle 1. Steer information may also include a predicted next turning rotation direction and a predicted next turning rotation speed of the steering wheel 50, which may be performed when the driver of the vehicle 1 sets a vehicle operation to be in an automatic drive mode, as further discussed below.

Further, the vehicle controller 200 is also in connection with an accelerator pedal sensor 14s which detects an operation amount of an accelerator pedal 14 and a brake pedal sensor 16s which detects an operation amount of a brake pedal 16. Based on these outputs from the sensors, the vehicle controller 200 generates information about the acceleration and deceleration of the vehicle 1 (i.e., acceleration/deceleration information), and outputs the generated information to the drive information output part 100.

Further, the vehicle 1 of the present embodiment is provided with a front camera 20 which captures a field image of a movement direction of the vehicle 1, a sonar 22 which detects an obstacle and/or a moving body around the vehicle 1, a navigation system 24 having a GPS function, a speed sensor 18s which detects a vehicle speed, together with other parts, and these devices are connected to the vehicle controller 200. Further, when the driver of the vehicle 1 sets a vehicle operation to be in an automatic drive mode, the vehicle controller 200 is capable of performing an automatic drive function of the vehicle 1, by driving a steer actuator 12a connected to the steering shaft 12, an accelerator actuator 14a connected to the accelerator pedal 14, and a brake actuator 16a connected to the brake pedal 16. Further, the steer actuator 12a may also be used to support and assist the rotation operation of the steering wheel 50 which is initially performed by the driver, even when the automatic drive mode is not set.

FIG. 2 shows a connection relationship between the vehicle controller 200 and various devices in the vehicle 1, such as the drive information output part 100 etc., collectively. The data from each of the front camera 20, the sonar 22, the navigation system 24, the steer angle sensor 12s, the accelerator pedal sensor 14s, and the brake pedal sensor 16s is inputted into the vehicle controller 200. Further, the steer actuator 12a, and the accelerator actuator 14a and the brake actuator 16a are controlled by the vehicle controller 200. Further, a result of the drive of the steering shaft 12 by the steer actuator 12a is detected by the steer angle sensor 12s, and is output to the vehicle controller 200. Other actuators serve in the same manner, that is, a result of the drive of the accelerator pedal 14 or the brake pedal 16 by the accelerator actuator 14a or the brake actuator 16a is similarly detected by the accelerator pedal sensor 14s or the brake pedal sensor 16s, and is similarly outputted to the vehicle controller 200. Further, the drive information output part 100 displays the drive information, such as the steer information and the acceleration/deceleration information, based on the information received from the vehicle controller 200.

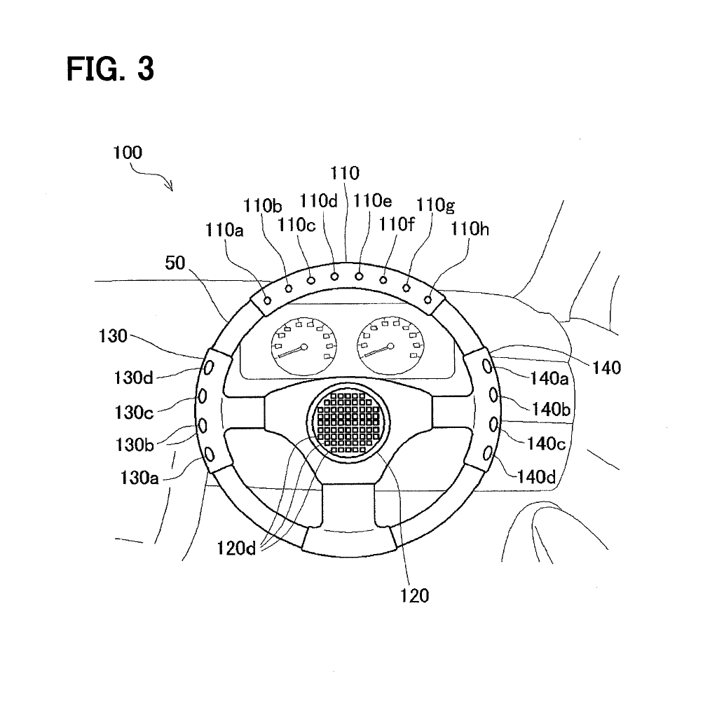

FIG. 3 shows an illustrative diagram of the drive information output part 100 of the present embodiment included in the steering wheel 50. The drive information output part 100 of the present embodiment includes a first output part 110 installed in an upper part of the steering wheel 50, a second output part 120 installed in a center part of the steering wheel 50, and a third output part 130 and a fourth output part 140 installed in a right part and a left part of the steering wheel 50.

Among those parts, the first output part 110 has eight small LED lamps 110a-h arranged in a row and spaced at equal intervals. The information about a steering direction and a steering speed (i.e., a angular rotation speed) of the steering wheel 50 may be displayed to the driver by lighting (i.e., turning on) these eight LED lamps 110a-h with a lighting time of each of those lamps shifted in small increments in the present embodiment. Details of how such information is output are mentioned later.

In the second output part 120, multiple lighting parts 120d are arranged in a grid shape (i.e., a matrix), constituting a dot matrix display as a whole. Further, in each of the lighting parts 120d of the present embodiment, a red LED that lights in a red color and a blue LED that lights in a blue color are built in, for allowing each of the lighting parts 120d to be illuminated in red or in blue. In the present embodiment, the information about the operation of the accelerator pedal 14 or the brake pedal 16 is displayed using the second output part 120. Details of how such information is output are mentioned later.

In each of the third output part 130 and the fourth output part 140, four vibrators 130a-d and 140a-d are embedded, respectively. In the present embodiment, a small motor having an eccentrically positioned disk attached to its axis is used as the vibrators 130a-d and 140a-d. However, the vibrators may be implemented differently, such as a piezo-element driven vibrator or the like. The vibrators 130a-d and vibrators 140a-d in the present embodiment may be vibrated with their vibration timings shifted in small increments in the right part and the left part of the steering wheel 50, for the output of the steering direction and the rotation speed of the steering wheel 50. Details of how such information output is performed are mentioned later.

The first output part 110, the third output part 130, and the fourth output part 140 of the present embodiment correspond to a “steer information output unit” of the present disclosure.

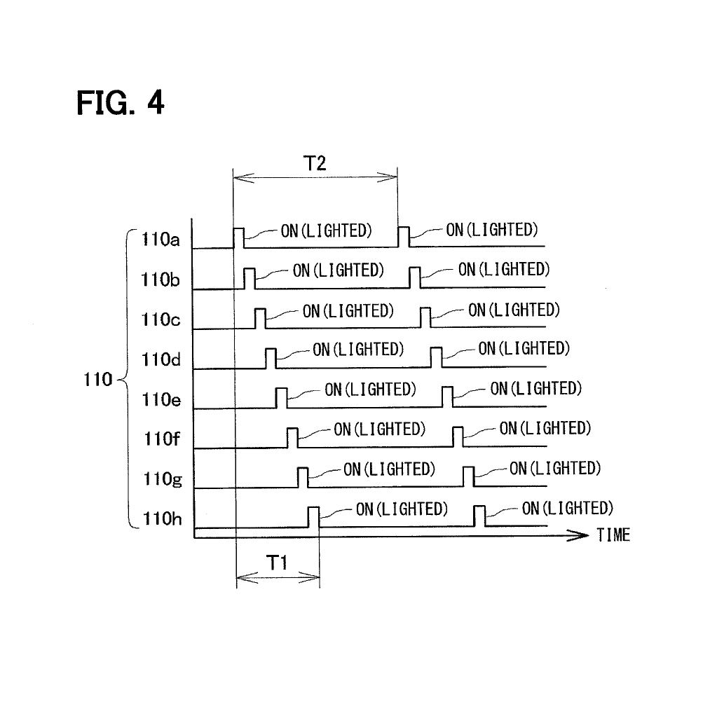

In FIG. 4, how the steering direction and the steering speed of the steering wheel 50 are displayed by the lighting (i.e., a turning-on) of the eight LED lamps 110a-h of the first output part 110 is illustrated. The timing for lighting the LED lamps 110a-h (i.e., turning-on of LED lamps 110a-h) are shifted in small increments from each other, i.e., from the lamp 110a toward the lamp 110h. As shown in FIG. 3, since the lamps 110a-h are arranged at equal intervals in the order of arrangement along a clockwise direction, the driver feels as if a light from the LED lamps 110a-h is moving in a clockwise direction when the lamps 10 a-h are illuminated (i.e., turned on) in the order of arrangement with a little shift of lighting timing from one lamp to the other.

Further, if a time T1 between a turning-on of the first LED lamp 110a to a turning-off of the eighth LED lamp 110h or a time T2 which is a cycle time of repeating the turning-on of the lamps 110a-h is changed, a light movement speed is changed.

Of course, if an order of lightings of the LED lamps 110a-h is reversed, the light moves in a counter-clockwise direction.

According to the above, when the lighting order and/or the times T1, T2 for lighting the LED lamps 110a-h are appropriately set, the steering direction and the steering speed of the steering wheel 50 are displayed based on the movement direction and the movement speed of the light.

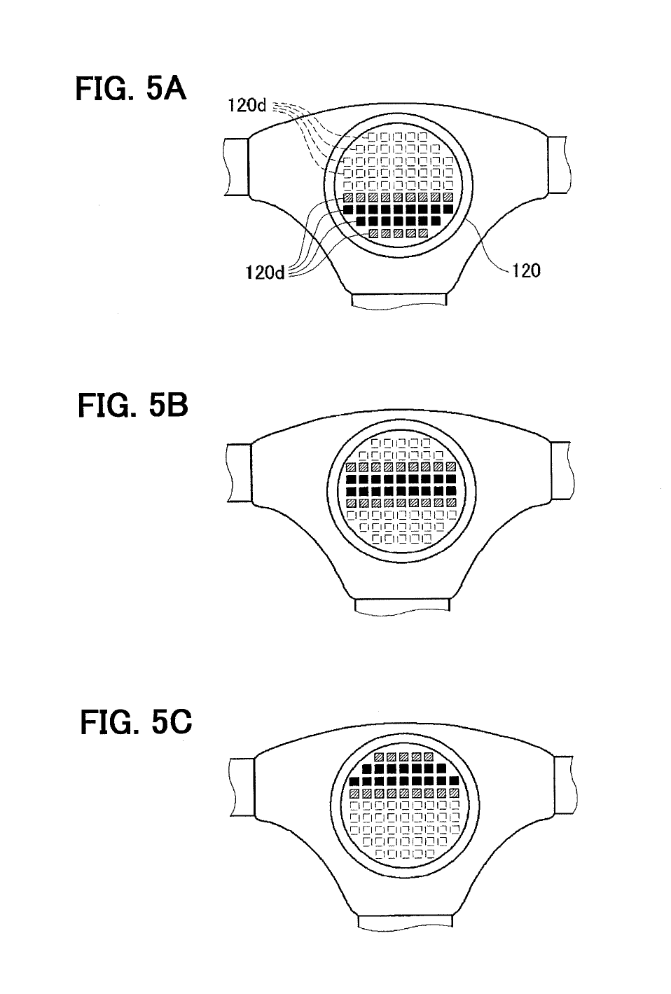

In FIGS. 5A/B/C, how the operation amount of the accelerator pedal 14 or the brake pedal 16 is displayed by the lighting of the multiple lighting parts 120d in the second output part 120 is illustrated. In the illustration, the lighting parts 120d drawn by a thin broken line are the lighting parts 120d currently turned off. The lighting parts 120d drawn with slash lines are the lighting part 120d that are currently weakly illuminated in blue or in red. The lighting parts 120d drawn as black squares are the lighting parts 120d strongly illuminated in blue or in red.

In an example of FIG. 5A, the lighting parts 120d in lower four rows are illuminated. If the row of the turned-on lighting parts 120d is shifted from one row to the other from a lower part toward an upper part of the lighting parts 120d, a horizontal light band moves from the lower part to the upper part, as shown in FIGS. 5A/5B/5C. Of course, if the turned-on lighting parts 120d are shifted from one row to the other from the upper part toward the lower part, the horizontal light band moves from the upper part to the lower part.

Further, the lighting parts 120d are, as mentioned above, turned on in blue or in red. Therefore, in the present embodiment, by making the lighting parts 120d turned on in blue, an operation amount of the accelerator pedal 14 is displayed, and, by making the lighting parts 120d turned on in red, an operation amount of the brake pedal 16 is displayed.

For example, when the driver is increasing an amount of pedal application of the accelerator pedal 14, the blue light band moves from the lower part to the upper part, and when the driver is decreasing an amount of stepping of the accelerator pedal 14, the blue light band moves from the upper part to the lower part. Further, when the driver maintains the amount of pedal application of the accelerator pedal 14 at a constant level, the blue light band is stays at a position corresponding to the constant amount of stepping. Further, according to a speed of the increase or returning of pedal application of the accelerator pedal 14 by the driver, the speed of the movement of the blue light band is changed.

The operation of the brake pedal 16 is similarly displayed by using a band of a red light. That is, when the driver increase an amount of pedal application of the brake pedal 16, a red light band moves from the lower part to the upper part, and when the driver is decreasing an amount of pedal application of the brake pedal 16, the red light band moves from the upper part to the lower part. Further, when the driver is maintains the amount of pedal application of the brake pedal 16 at a constant level, the red light band stays at a position corresponding to the constant amount of brake pedal application.

Further, according to a speed of the increase or returning of pedal application of the brake pedal 16, the speed of the movement of the red light band is changed.

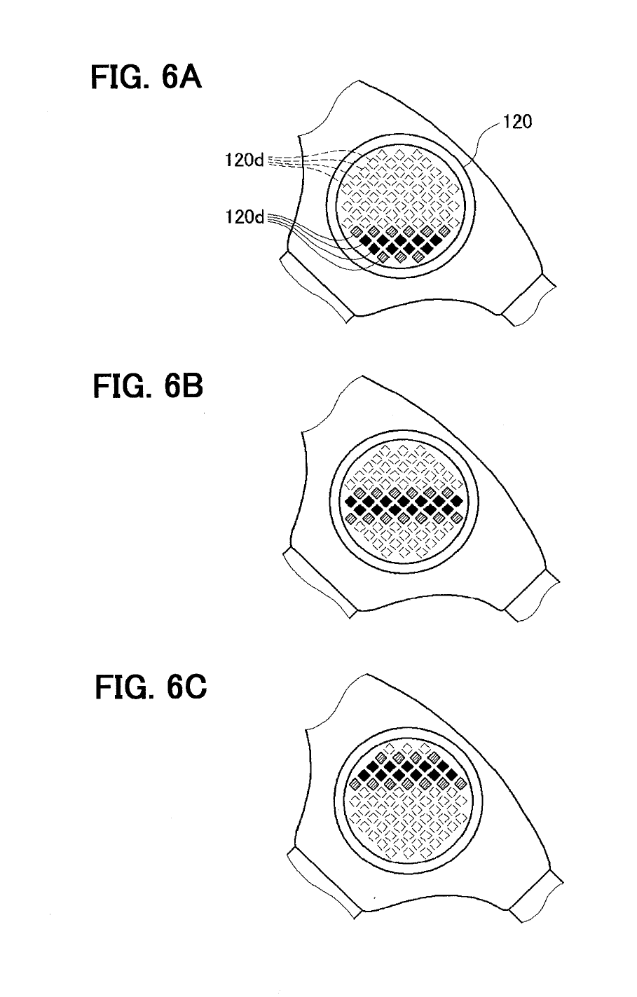

When the steering wheel 50 is steered and rotated, the second output part 120 is rotated. However, even when the second output part 120 is rotated, the blue or red light band is controlled to move from the lower part to the upper part or from the upper part to the lower part as shown in FIGS. 6A/B/C, by lighting the lighting parts 120d in consideration of the steer angle of the second output part 120.

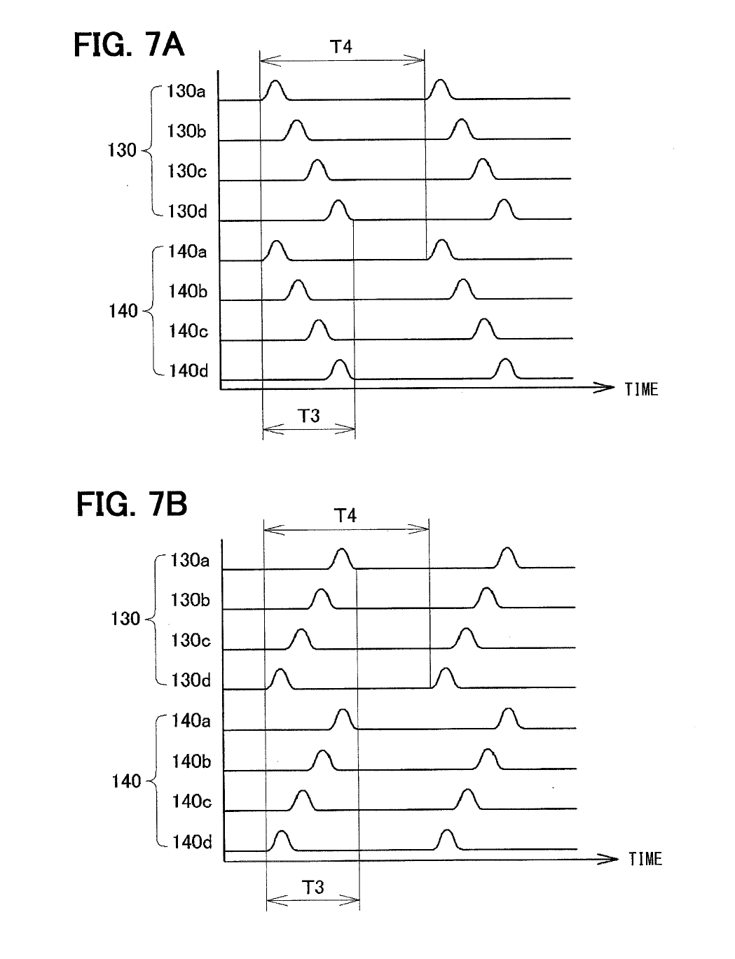

In FIGS. 7A/B, how the steer direction and the steering speed of the steering wheel 50 are displayed by vibrating the four vibrators 130a-d of the third output part 130 and the four vibrators 140a-d of the fourth output part 140 is illustrated. As mentioned above, the motor with a small eccentric disk is used in each of the vibrators 130a-d and 140a-d in the present embodiment. Therefore, the vibrators 130a-d and 140a-d can be vibrated once by controlling the motor to perform a single turn. Further, as shown in FIG. 3, the vibrators 130a-d and the vibrators 140a-d are disposed at positions where the driver grips the steering wheel 50.

Thus, as shown in FIG. 7A, the vibrators 130a-d are respectively vibrated once in an order of arrangement on the steering wheel 50 (i.e., from 130a to 130d) with a short time shift caused in between each of such vibrations. The vibrators 140a-d are also respectively vibrated once in an order of arrangement on the steering wheel 50 (i.e., from 140a to 140d) with a short time shift caused in between each of such vibrations in the same manner. The driver feels that, according to such vibration arrangement, the vibrating part moves in a clockwise direction in small increments under the gripped portion of the steering wheel 50.

Further, by changing a time T3 between a vibration of a first vibrator 130a (or a first vibrator 140a) and a vibration of a fourth vibrator 130d (or a fourth vibrator 140d) as well as by changing a time T4 which corresponds to a cycle time of repeating a vibration of the vibrators 130a-d (or the vibrators 140a-d), the movement speed of the vibrating part is changed.

Further, as shown in FIG. 7B, when the vibrators 130a-d and the vibrators 140a-d are respectively vibrated once in a reversed order of arrangement on the steering wheel 50 (i.e., from 130d to 130a) with a short time shift caused in between each of such vibrations, such vibration arrangement is provided for the driver as a feel that the vibrating part moves in a counter-clockwise direction in small increments under the gripped portion of the steering wheel 50.

Therefore, by appropriately setting an order of vibration of the vibrators 130a-d of the third output part 130 and the vibrators 140a-d of the fourth output part 140 and/or by appropriately setting the times T3 and T4, through the feel of the driver's hand regarding a vibration position movement direction and a vibration position movement speed, the steer direction and the steering speed of the steering wheel 50 are conveyed to the driver.

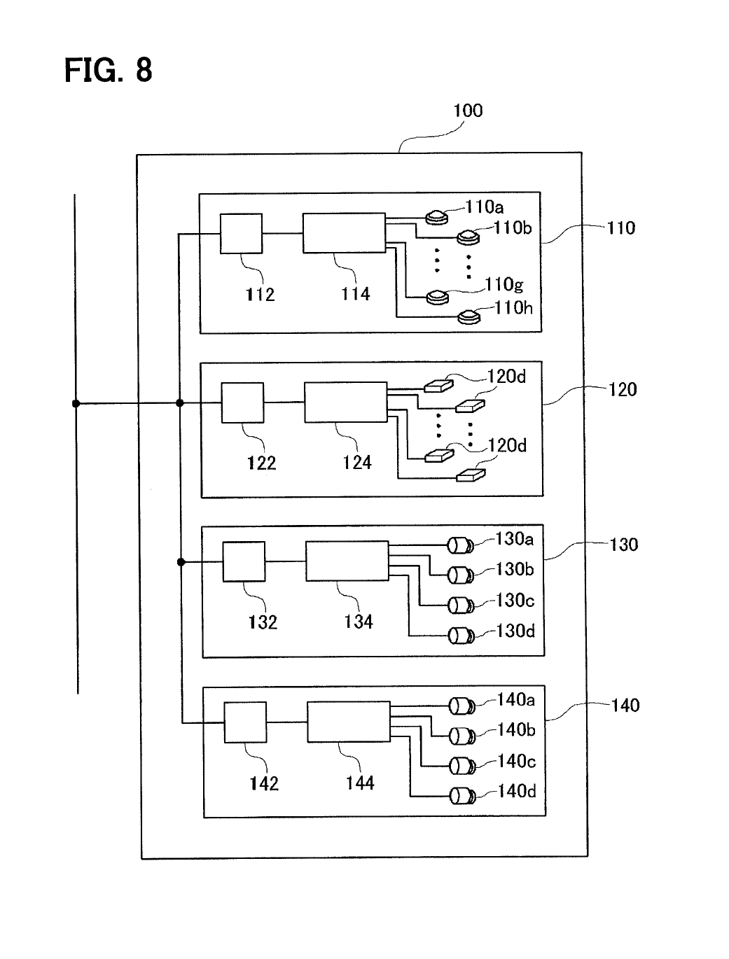

The internal configuration of the drive information output part 100 for outputting various kinds of information in the above-described manner is shown in FIG. 8. First, the first output part 110 of the drive information output part 100 is equipped with a communication part 112, a signal generating part 114, and the LED lamps 110a-h.

Among the above parts, the communication part 112 receives the information (i.e., the steer information) about the steering direction and the steering speed of the steering wheel 50 through communications with the vehicle controller 200. Further, the signal generating part 114 generates a drive signal for driving the LED lamps 110a-h based on the steer information received by the communication part 112.

For example, when a steering direction is a clockwise direction, the LED lamps 110a-h are illuminated in the order as mentioned above with reference to FIG. 4. Further, when the steering speed is low, the times T1 and T2 are set as a large value, and, as the steering speed increases, the times T1 and T2 are made smaller. In such manner, the generated drive signal is outputted to the LED lamps 110a-h, and the LED lamps 110a-h are turned on. In such manner, the steering direction of the steering wheel 50 is displayed by the movement direction of the light, and the steering speed of the steering wheel 50 is displayed with the movement speed of the light.

Similar to the first output part 110, the second output part 120 has a communication part 122 for communication with the vehicle controller 200, a signal generating part 124 for generating the drive signal for driving the multiple lighting parts 120d arranged in a grid shape, and the multiple lighting parts 120d.

Among the above parts, the communication part 122 receives the information (i.e., the acceleration/deceleration information) including the amount of pedal application and the increasing/returning speed of the pedal application of each of the accelerator pedal 14 and the brake pedal 16 and the information on the steer angle of the steering wheel 50 from the vehicle controller 200, and outputs the information to the signal generating part 124.

The signal generating part 124 determines, in response to which one of the accelerator pedal 14 or the brake pedal 16 is being operated, a color of the lighting parts 120d, and also determines, in response to whether the application amount of the pedal 14 or 16 is increasing or decreasing, the movement direction (i.e., up or down) of the light band in the lighting parts 120d, and further determines, in response to the pedal application speed or the returning speed of the pedal 14 or 16, the movement speed of the light band. Further, when the amount of pedal application of the pedal is kept at a constant level, the light band position (i.e., a distance from the lower part) is determined according to the amount of pedal application. Then, in consideration of the steer angle of the steering wheel 50, a drive signal for driving each of the lighting parts 120d is generated, and the generated drive signal is output to the target lighting part 120d. In such manner, as mentioned above with reference to FIGS. 5 and 6, the information about the operation of the accelerator pedal 14 or about the operation of the brake pedal 16 is displayed by using the light band displayed on the second output part 120.

Further, the third output part 130 and the fourth output part 140 also have, respectively, communication parts 132, 142, signal generating parts 134, 144, and the vibrators 130a-d and 140a-d.

The communication parts 132, 142 communicate with the vehicle controller 200, and receive the information (i.e., the steer information) about the steering direction and the steering speed of the steering wheel 50. Then, the signal generating part 134 generates the drive signal for driving the vibrators 130a-d based on the steer information that is received by the communication part 132. Also, the signal generating part 144 generates the drive signal for driving the vibrators 140a-d based on the steer information that is received by the communication part 142. At such time, according to the steering direction of the steering wheel 50, the order of vibrating the vibrators 130a-d and the vibrators 140a-d is set, and, according to the steering speed of the steering wheel 50, the time T3 and the time T4 shown in FIG. 7 are set.

In such manner, the generated drive signal is outputted to the vibrators 130a-d and 140a-d, and the vibrators 130a-d and 140a-d are vibrated. As mentioned above with reference to FIG. 3, since the vibrators 130a-d and 140a-d are disposed at the position where the driver grips the steering wheel 50, the steer direction and the steering speed of the steering wheel 50 are conveyed to the driver through the feel of the driver's hand regarding a vibration position movement direction and a vibration position movement speed, which are presented for the driver as the vibration of the vibrators 130a-d and 140a-d in the above-described manner.

B. Drive Information Output Process:

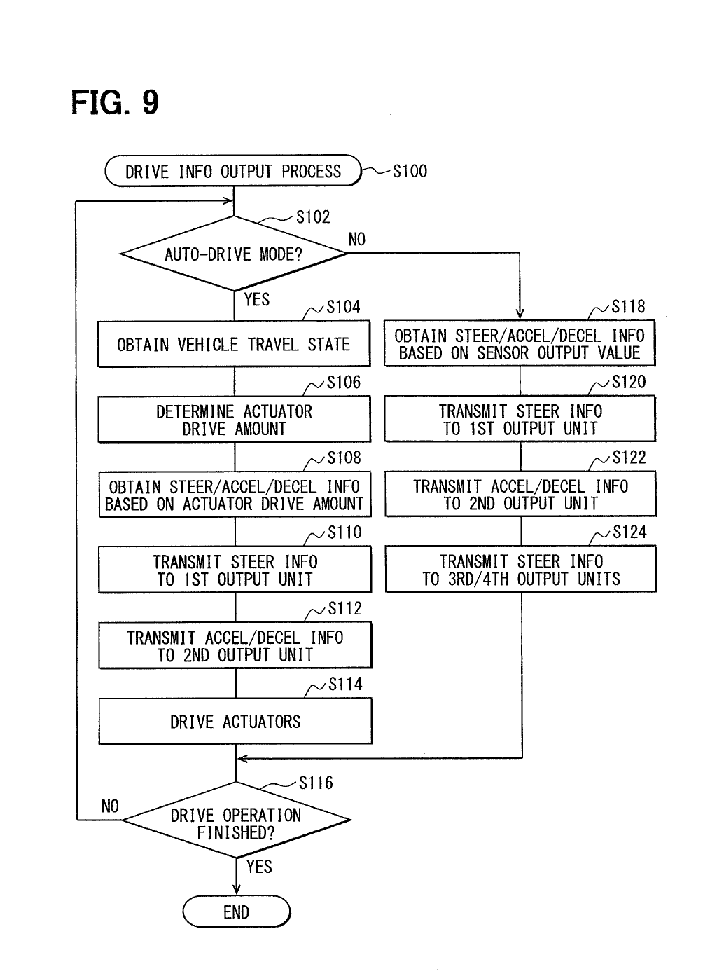

The flow chart of the drive information output process performed by the driving support apparatus 10 in the present embodiment is shown in FIG. 9. The driving support apparatus 10 uses the drive information output part 100 to output the drive information (i.e., the steer information and the acceleration/deceleration information). This process is executed by the vehicle controller 200 of the driving support apparatus 10.

In the drive information output process, it is determined initially whether the automatic drive mode is set by the driver (S102). When the automatic drive mode is being set (S102:YES), a travel state of the vehicle 1 is obtained based on the data from the front camera 20, the sonar 22, the navigation system 24, the speed sensor 18s, the steer angle sensor 12s, the accelerator pedal sensor 14s, the brake pedal sensor 16s, etc. (S104). Then, based on the data, a drive amount of each of the steer actuator 12a, the accelerator actuator 14a and the brake actuator 16a is determined (S106).

Then, the steer information (i.e., the predicted steering direction and predicted the steering speed of the steering wheel 50) and the acceleration/deceleration information (i.e., the operation amount, the operation direction and the operation speed of the accelerator pedal 14 or the brake pedal 16) are obtained based on the drive amount of each of these actuators (S108). Then, the obtained steer information is transmitted to the first output part 110 (S110), and the obtained acceleration/deceleration information is transmitted to the second output part 120 (S112).

As mentioned above with reference to FIG. 8, after a reception of the steer information by the communication part 112, the drive signal is generated by the signal generating part 114, and the LED lamps 110a-h are turned on based on such drive signal. As a result, the driver is enabled to visually recognize the information about how the steering wheel 50 is going to be steered by the automatic drive function.

Further, after a reception of the acceleration/deceleration information by the communication part 122, the drive signal is generated by the signal generating part 124, and the multiple lighting parts 120d are turned on based on the drive signal. As a result, the driver is enabled to visually recognize the information about how the accelerator pedal 14 and the brake pedal 16 are going to be operated by the automatic drive function.

As shown in FIG. 3, the third output part 130 and the fourth output part 140 which output the steer information by using a driver's tactile sense are also installed in the drive information output part 100. However, in the automatic drive mode, the steer information will not be transmitted to the third output part 130 or to the fourth output part 140, because the driver in the automatic drive mode may be in a hands-off condition, i.e., the driver in the automatic drive mode is in many cases considered as not gripping the steering wheel 50. That is, when the driver's hands are off the steering wheel 50, the steer information cannot be transmitted to the driver from the third output part 130 or from the fourth output part 140.

In such manner, after transmitting the steer information and the acceleration/deceleration information toward the first output part 110 and the second output part 120, the steer actuator 12a, the accelerator actuator 14a and the brake actuator 16a are driven according to the previously determined drive amount (S114). Then, the result of the driving of each of those actuators is detected by the steer angle sensor 12s, the accelerator pedal sensor 14s, and the brake pedal sensor 16s, and is reflected in the travel condition of the vehicle 1, which is obtained in S104, together with the vehicle speed detected by the speed sensor 18s.

Then, it is determined whether a drive operation of the vehicle 1 is finished (S116), and the process returns to a start and determines whether the drive operation of the vehicle 1 is in the automatic drive mode (S102) when it is determined that the drive operation is not yet finished. When it is determined to be in the automatic drive mode (S102:YES), the process in subsequent steps (S104-S116) mentioned above is repeated.

Since the steer actuator 12a drives the steering shaft 12 that is connected to the steering wheel 50, it corresponds to a “drive unit” in the present disclosure. Further, since the steer actuator 12a is controlled by the vehicle controller 200, the vehicle controller 200 of the present embodiment corresponds to a “drive controller” in the present disclosure. Furthermore, since whether the automatic drive mode is being set is determined by the vehicle controller 200, the vehicle controller 200 of the present embodiment also corresponds to a “determination unit” in the present disclosure.

In the above, a case in which it is determined that the automatic drive mode is set by the driver (S102:YES) is described. On the other hand, when it is determined that the automatic drive mode is not set (S102:NO), the vehicle controller 200 detects output values of the steer angle sensor 12s, the accelerator pedal sensor 14s, and the brake pedal sensor 16s, and obtains the steer information (i.e., the steering direction and the rotation speed of the steering wheel 50 that may be performed by the driver) and the acceleration/deceleration information (i.e., an operation amount of the accelerator pedal 14 or the brake pedal 16, an operation direction, and an operating speed) from these output values (S118).

Further, the obtained steer information is transmitted to the first output part 110 (S120), and the obtained acceleration/deceleration information is transmitted to the second output part 120 (S122). As a result, in the automatic mode, the information about the steer direction and the steering speed regarding the steering operation of the steering wheel 50 as well as the information about the pedal operation actually performed on the accelerator pedal 14 and the brake pedal 16 are visually conveyed to a visual sense of the driver.

Further, when not in the automatic drive mode, the steer information is transmitted also to the third output part 130 and to the fourth output part 140 (S124). When not in the automatic drive mode, the driver is considered to be gripping the steering wheel 50. Therefore, the steer information is conveyed to a tactile sense of the driver through the vibration of the vibrators 130a-d and 140a-d, if the steer information is transmitted to the third output part 130 and the fourth output part 140.

Further, a process that obtains the steer information from the drive amount of the steer actuator 12a or from the output value of the steer angle sensor 12s is performed by the vehicle controller 200 (S108 or S118) in the drive information output process. Therefore, the vehicle controller 200 of the present embodiment corresponds to a “steer information obtain unit” in the present disclosure.

Then, it is determined whether the drive operation of the vehicle 1 is finished (S116), and, the process returns to a start and determines whether the drive of the vehicle 1 is in the automatic drive mode (S102) when it is determined that the drive is not yet terminated. When it is determined that the drive is not in the automatic drive mode (S102:NO), the process in subsequent steps (S118-S126) mentioned above is repeated.

Further, if it is determined that the drive of the vehicle 1 is terminated while repeating such process (S116:YES), the drive information output process shown in FIG. 9 will be finished.

As described above, in the driving support apparatus 10 of the present embodiment, the steer information on the steering wheel 50 is conveyed to the driver through a visual sense or a tactile sense by using the first output part 110, the third output part 130 and/or the fourth output part 140 which are all installed in and/or on the steering wheel 50. Further, since the steer information is directly related to the movement direction of the vehicle 1, it is very important information for the driver. Now, as mentioned above, the driving support apparatus 10 in the present embodiment is capable of conveying such important information in a readily and intuitively understandable form, through a visual sense or through a tactile sense, thereby lightening the driver's load for receiving such important information. As a result, the driver's readiness for receiving other information, with lower importance or even with high importance and a demand for quicker attention, is increased, thus providing a greater safety margin, for example. Thus, even when various kinds of driving support techniques are implemented in the vehicle 1, the driver is prevented from being pressured and/or overloaded by a flood of information.

Further, in the driving support apparatus 10 of the present embodiment, the acceleration/deceleration information about the operation of the accelerator pedal 14 or the brake pedal 16 can also be visually conveyed to the driver by using the second output part 120 installed in the steering wheel 50. Since the operation of the accelerator pedal 14 or the brake pedal 16 is directly related to the travel speed of the vehicle 1, it is the information having almost the same importance as the steer information for the driver. Now, in the driving support apparatus 10 of the present embodiment, the acceleration/deceleration information is also intuitively conveyed to the driver in a readily understandable visual manner, which further reduces the driver's burden. As a result, the driver's readiness for receiving other information, which may have lower importance than the steer information or the acceleration/deceleration information, is increased, thus providing a greater safety margin, for example. Thus, even when various kinds of driving support techniques are implemented in the vehicle 1, the driver is prevented from being pressurized and/or overloaded by the flood of information.

Further, even when the steering wheel 50 is not being actually operated, the driver can recognize the steer information through the driver's vision or tactile sense if the vehicle 1 is equipped with the driving support apparatus 10 of the present embodiment which has the first output part 110, the third output part 130 and the fourth output part 140. Similarly, with the help of the second output part 120, even when the operation of the accelerator pedal 14 or the brake pedal 16 is not actually being performed, the driver is enabled to visually recognize the acceleration/deceleration information through the driver's vision. Therefore, when the vehicle 1 is traveling in the automatic drive mode, the driver receives a pre-operation notice prior to an actual drive operation that may be performed by the automatic drive function, such as a steering operation of the steering wheel 50, a stepping operation of the accelerator pedal 14 or the brake pedal 16. That is, the contents of these operations can be notified to the driver prior to the actual operation. For example, as soon as the vehicle controller 200 determines the contents of a driving or actuation of the steer actuator 12a, the accelerator actuator 14a and/or the brake actuator 16a, the information about the contents of the driving or actuation of those actuators may be output to the drive information output part 100, before those actuators will actually be driven.

Since the vehicle controller 200 cannot detect all the information that is recognizable by the driver, the contents of the drive operation by the automatic drive function may not always be in accords with the driver's intention. However, since the driver is notified about the contents of the drive operation by the automatic drive function prior to the actual operation (i.e., before the operation is carried out), such notification also makes it possible for the driver to stop and/or prevent such an un-desired operation which is not in accords with the driver's intention and/or the operation unsuitable with the surrounding traffic situation.

C. Modification:

In the embodiment mentioned above, in order to convey the steer information through the tactile sense of the driver, the third output part 130 having the vibrators 130a-d buried therein and the fourth output part 140 having the vibrators 140a-d buried therein are used on the right and left portions of the steering wheel 50. However, the method of conveying the steer information through the tactile sense of the driver is not restricted to the method which uses the vibrators 130a-d and 140a-d. For example, the driving support apparatus may also convey the steer information through the tactile sense of the driver by using a rotary ring 150 disposed on a circumference of the steering wheel 50 and by rotating such rotary ring 150 relative to the steering wheel 50.

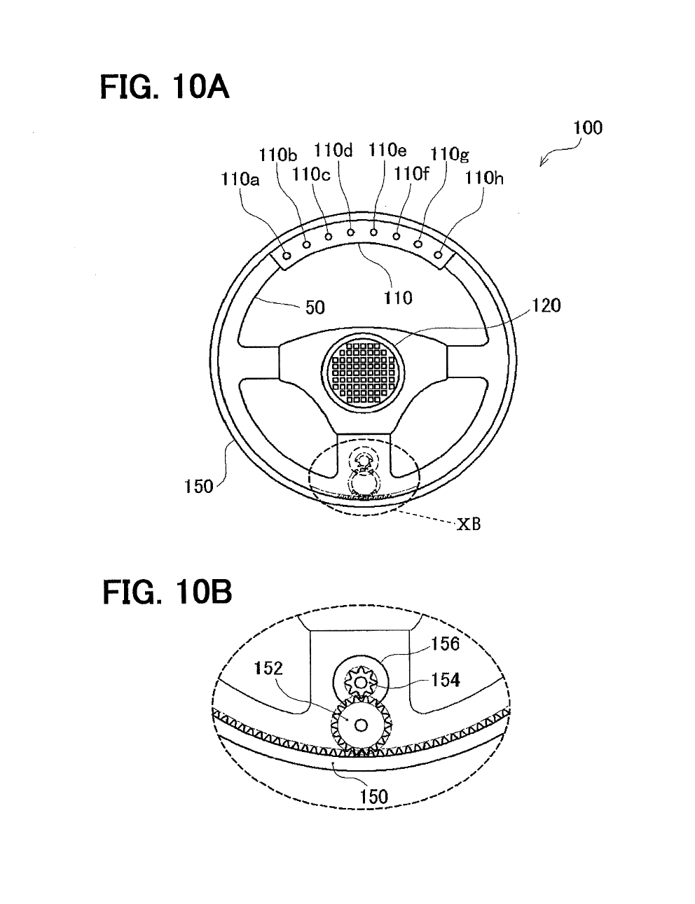

FIG. 10A shows an illustration of a modification example of the drive information output part 100 having the rotary ring 150 installed therein. As shown in the illustration, the drive information output part 100 of the modification example has, the first output part 110 is installed in the upper part of the steering wheel 50. The second output part 120 is installed in the center of the steering wheel 50. Since these parts 110 and 120 are same as the one in the embodiment described above, the detail description is not repeated.

Further, the drive information output part 100 of the modification example has, on a circumference of the steering wheel 50, the rotary ring 150 that is rotatably disposed relative to the steering wheel 50. In an inside of the rotary ring 150, a gear is provided, and the rotary ring 150 is rotated by using a small motor installed in the steering wheel 50.

FIG. 10B shows an illustration of mechanism by which a motor 156 drives the rotary ring 150. As illustrated, a small drive gear 154 is attached to a rotation shaft of the motor 156. Further, the drive gear 154 is engaged with a middle gear 152, and the middle gear 152 is engaged with another gear in an inside of the rotary ring 150. In such structure, if the motor 156 is driven to rotate in a clockwise direction, such rotation is transmitted with its rotation speed reduced by the middle gear 152, and the rotary ring 150 rotates slowly in the clockwise direction. If the rotation speed of the motor 156 is changed, the rotation speed of the rotary ring 150 is also changed. If the motor 156 is rotated in a counter clockwise direction, the rotary ring 150 is rotated in the counter clockwise direction.

In the drive information output part 100 in the modification example, the rotary ring 150 may be rotated in a direction that is in accordance with the steering direction of the steering wheel 50, and the rotary ring 150 may be rotated at a speed that is according to the steering speed of the steering wheel 50. In such manner, through the tactile sense of the driver's hand which is grasping the steering wheel 50, it may be possible for the driver to recognize the steer information, i.e., how the steering wheel 50 will going to be steered.

Although the present disclosure has been fully described in connection with preferred embodiment thereof with reference to the accompanying drawings, it is to be noted that various changes and modifications will become apparent to those skilled in the art, and such changes, modifications, and summarized scheme are to be understood as being within the scope of the present disclosure as defined by appended claims.

What is claimed is:

1. A driving support apparatus installed in a vehicle and supporting a driver driving the vehicle, the driving support apparatus comprising:
a steering wheel controlling a directional movement of the vehicle;
a steer information obtain unit obtaining steer information about a rotation operation of the steering wheel; and
a steer information output unit installed in the steering wheel and outputting the steer information to the driver.

2. The driving support apparatus of claim 1, wherein
the steer information obtain unit obtains the steer information by detecting a rotation operation of the steering wheel that is performed by the driver.

3. The driving support apparatus of claim 1, wherein
the steer information includes a rotation direction of the steering wheel.

4. The driving support apparatus of claim 1, wherein
the steer information includes a rotation speed of the steering wheel.

5. The driving support apparatus of claim 1, wherein
the steer information output unit visually outputs the steer information to a visual sense of the driver.

6. The driving support apparatus of claim 1, wherein
the steer information output unit tactily outputs the steer information to a tactile sense of the driver.

7. The driving support apparatus of claim 1 further comprising:
a drive unit rotationally driving the steering wheel; and
a drive controller controlling the drive unit to rotationally drive the steering wheel, wherein
the steer information obtain unit obtains the steer information based on a control amount of the drive unit that is controlled by the drive controller.

8. The driving support apparatus of claim 7 further comprising:
a manual driving state in which the driver performs the rotation operation of the steering wheel;
an automatic driving state in which the drive unit performs the rotational drive of the steering wheel; and
a determination unit determining whether the vehicle is in the manual driving state or the automatic driving state, wherein
when in the manual driving state, the steer information output unit tactily outputs the steer information to a tactile sense of the driver, and
when in the automatic driving state, the steer information output unit visually outputs the steer information to a visual sense of the driver.

9. The driving support apparatus of claim 8, wherein
when in the automatic driving state, the steer information output unit outputs the steer information to the driver prior to the drive unit rotationally driving the steering wheel.
